(19) United States
(12) Patent Application Publication
(10) Pub. No.: US 2016/0076949 A1
(43) Pub. Date: Mar. 17, 2016

(54) WIRELESS CULINARY PROBE CALIBRATION METHOD AND SYSTEM

(71) Applicant: Knowles Capital Formation Inc., Itasca, IL (US)

(72) Inventors: Sabah Sabah, Nashua, NH (US); Marcus Baier, Hassmersheim (DE)

(21) Appl. No.: 14/949,221

(22) Filed: Nov. 23, 2015

Related U.S. Application Data
(63) Continuation of application No. PCT/US14/40184, filed on May 30, 2014.
(60) Provisional application No. 61/828,803, filed on May 30, 2013.

(51) Int. Cl. G01K 15/00; G01K 13/00; G01K 11/26

(52) U.S. Cl. CPC G01K 15/005; G01K 11/265; G01K 13/00

(57) ABSTRACT

A system and method to calibrate a temperature probe through immersion in a substance of known change of state temperature. The saturated Surface Acoustic Wave (SAW) probe temperature signal is calculated, overcoming oven reference temperature variability.

### RELATED APPLICATIONS

This application is a continuation of PCT Application No. PCT/US2014/040184 filed 30 May 2014 which claims the benefit of U.S. Provisional Application No. 61/828,803 filed 30 May, 2013. Each of these applications is herein incorporated by reference in their entirety for all purposes.

### FIELD OF THE INVENTION

The invention relates to a method and system for calibrating a wireless culinary temperature probe.

### BACKGROUND OF THE INVENTION

A wide range of cooking appliances include heating elements, such as ovens, kettles, steamers, rice cookers, food processors, crock pots, etc. It is important that these appliances accurately control the temperature to which food is heated to ensure that it is neither undercooked nor overcooked. Therefore, heating appliances are typically provided with a temperature sensor to monitor a temperature of the heating element or food. The power supply to the heating element is controlled by the readings of the temperature sensor in order to maintain this temperature within a predetermined range. However, temperature sensors, especially for food in oven applications, often have a high variability or inaccuracy. This can lead to improperly cooked food. Variability or inaccuracy can be reduced, for example, by screening the food probes or temperature sensors, grouping food probes or temperature sensors to average values within a defined span, or calibrating the food probe using a reference temperature sensor in the oven. Applications require multiple sensors for calibration. This can be cumbersome and may not be reliable. Existing temperature sensor types include resistance (Pt100/Pt1000), thermocouple (NiCr/NiAl), and thermistor elements (NTC). Each requires wires, and some can be quite fragile. The combination of being low cost, inherently rugged, very sensitive, intrinsically reliable, wireless, and requiring no power is difficult to achieve.

What is needed is a system and method for establishing a reliable, accurate, fast reaction time temperature readout of wireless food probe temperatures sensors.

### SUMMARY OF THE INVENTION

An embodiment provides an apparatus for calibrated control of a cooking oven comprising an oven heat source; a thermostat providing temperature control signals to the heat source; a wireless temperature probe, the probe comprising a sensor body, at least one surface acoustic wave (SAW) temperature sensor, and at least one sensor antenna; a separate probe transceiver calibration unit receiving temperature information from the temperature sensor of the probe, the probe transceiver calibration unit comprising an antenna electrically connected to the probe transceiver calibration unit; a calibration material in a calibration material container; the probe transceiver calibration unit receiving thermal properties of the calibration material and configured to calculate a calibration factor to apply to a decoded uncalibrated temperature reading from the probe, producing a calibrated temperature from the probe; whereby the oven thermostat receives calibrated temperature reading control input from the probe transceiver calibration unit. Embodiments comprise a pre-calibration sequence. In other embodiments, the probe is calibrated without a reference temperature sensor. In subsequent embodiments the calibration is accomplished at a single temperature point, and calibration calculations are performed in the probe calibration unit. For additional embodiments the probe comprises a response time of at least about one second, an accuracy of about 0.5 degrees C., a precision of about at least 0.5 degrees C., a linearity of about 1% over a temperature range of about 0 to about 250 degrees C., and a drift of less than about 0.1 degree C. per year. In another embodiment, the quantity of the calibration material is minimized. Yet further embodiments comprise ending a pre-calibration sequence when SAW sensor measured temperature varies by no more than approximately 0.5 degrees Celsius.

Another embodiment provides a method for calibrating a culinary probe comprising the steps of providing a calibration material; placing one sensor in the calibration material in an oven; beginning a heating operation by controlling a heat source by a thermostat; detecting a temperature plateau of the calibration material in a probe calibration unit; adjusting a reading of the sensor to correspond to a calibration temperature; saving settings; and controlling the heat source by the thermostat receiving calibrated temperature control input from the probe calibration unit. A following embodiment comprises receiving information about heating power, thermal properties of the calibration material; probe unique identifier; and calibration material unique identifier at the probe calibration unit, and recording, at the probe calibration unit, the time at which the temperature of the calibration material does not increase. Subsequent embodiments comprise storing, in the probe calibration unit, the information about a correlation between the time at which the calibration material temperature does not increase and thermal properties of the calibration material; and the probe unique identifier. Additional embodiments comprise calculating, in the probe calibration unit, a calibration factor to apply to the decoded uncalibrated temperature reading from the probe, producing a calibrated temperature from the probe. Included embodiments comprise a pre-calibration sequence comprising activating a SAW temperature sensor with an RF signal; decoding uncalibrated temperature and probe ID from a SAW response signal; saving the uncalibrated temperature associated with the probe and calibration material identifications and time; waiting for a measurement interval; repeating the activating decoding and saving cycle; comparing consecutive uncalibrated temperatures from the SAW; checking to determine if temperature is unchanged, stable at ambient temperature; if not unchanged, wait for the measurement interval, if unchanged, the temperature is stable at ambient temperature, ending the pre-calibration sequence. Related embodiments comprise collecting approximately 300 data points for calibration calculation, and collecting data from the probe at about one second intervals. Further embodiments comprise immersing the probe in water calibration material, and removing the calibration material from the oven after completion of calibration and cooking initiation.

A yet further embodiment provides a system for calibrating a culinary probe comprising activating a SAW temperature sensor with an RF signal; decoding uncalibrated temperature and probe ID from a SAW response signal; saving the uncalibrated temperature associated with the probe and calibration material identifications and time; waiting for a measurement interval; repeating the activating decoding and saving cycle; comparing consecutive uncalibrated temperatures from the SAW temperature sensor; checking to determine if the temperature is unchanged, stable at ambient temperature; beginning energizing a heat source controlled by a thermostat; performing a sequence comprising activating the SAW sensor, decoding a SAW sensor response, saving the SAW response, probe and calibration material identifications, and time; waiting for the measurement interval; comparing consecutive uncalibrated temperature sensor responses from the SAW sensor; checking to determine if the temperature reading has increased; if temperature has increased, repeating the activating decoding saving cycle steps; if the temperature has not increased, confirm that the heat source is on; collecting a predetermined quantity of uncalibrated temperature reading repetitions at the stable temperature; calculating and saving a calibration factor for the SAW probe and the material by the respective identifications; de-energizing the heat source; ending calibration steps; and controlling the heat source by the thermostat receiving calibrated temperature control input from the probe transceiver calibration unit. Ensuing embodiments comprise collecting a predetermined quantity of uncalibrated temperature reading repetitions at the stable temperature only if the heat source is confirmed to be on. Yet further embodiments comprise setting a setpoint temperature of the thermostat to at least a change-of-state temperature of the calibration material. More embodiments comprise energizing the heat source if the heat source is determined to not be on at the step of confirming that said heat source is on. For additional embodiments, power supplied to the heat source during heating is varied proportionate to the thermal inertia of the calibration material, whereby a given time for calibration is maintained. Continued embodiments include requesting calibration to initiate the calibration at the probe transceiver calibration unit; selecting the calibration material; programming a controller in the probe transceiver calibration unit with calibration material physical properties values including change-of-state temperature; identifying the probe from the probe ID from the RF signal; confirming SAW temperature sensor operation with an RF signal; transferring control of the heat source to the probe transceiver calibration unit from the thermostat.

The features and advantages described herein are not all-inclusive and, in particular, many additional features and advantages will be apparent to one of ordinary skill in the art in view of the drawings, specification, and claims. Moreover, it should be noted that the language used in the specification has been principally selected for readability and instructional purposes, and not to limit the scope of the inventive subject matter.

### BRIEF DESCRIPTION OF THE DRAWINGS

FIG. 1 depicts a simplified calibration environment for an embodiment of the present invention.

FIG. 2 depicts a SAW probe, receptacle, and calibration material for an embodiment of the present invention.

FIG. 3 depicts components of a system overview for an embodiment of the present invention.

FIG. 4 depicts a schematic of component operation for an embodiment configured in accordance with the present invention.

FIG. 5 depicts a calibration material phase diagram for an embodiment of the present invention.

FIG. 6 depicts a water liquid-vapor applied heat diagram for an embodiment of the present invention.

FIG. 7 depicts a temperature reading curve for an embodiment of the present invention.

FIG. 8 depicts a temperature curve for oven heating during calibration for an embodiment of the present invention.

FIG. 9 is a system flow chart of an overview of a method for calibrating at least one wireless food probe configured in accordance with the present invention.

FIG. 10 is a flow chart of a method for control unit operation for calibrating at least one wireless food probe configured in accordance with an embodiment of the present invention.

FIG. 11 is a flow chart of details of a method for calibrating at least one wireless food probe configured in accordance with an embodiment of the present invention.

### DETAILED DESCRIPTION

For oven application embodiments, the oven is heated to a temperature above the change of state temperature of the liquid, and the food probe temperature is observed. Liquid water as the calibration liquid changes state at 100° C. In embodiments, the calibration material may comprise a liquid, a solid, or a mixture of liquids and solids. Fast sensor reaction time means quick response to temperature changes both during calibration and cooking, reducing temperature overshoot and undershoot.

Once saturation (temperature plateau) of the food probe temperature (output signal) is detected, the calibration can be performed by taking the cooking temperature of the (calibration) liquid under consideration. By using this method, the oven reference temperature tolerance can be neglected.

The power supplied to the heating element during heating may be varied depending on the thermal inertia of the material being heated. For example, a material with a high specific heat capacity and low thermal conductivity will require more energy to be heated to a specific temperature, than a material with a low specific heat capacity and high thermal conductivity. To maintain a given time for calibration, more heat would need to be applied than for a material with a low specific heat capacity and/or a high thermal conductivity. The rate at which the power is supplied is dependent on the thermal inertia of the material being heated. The thermal inertia takes into account such factors as volume of material, specific heat capacity, and thermal conductivity. For example, a larger volume of water will have a higher thermal inertia than a smaller volume, since more energy is required to heat the larger volume to any given temperature. In embodiments, the quantity of the calibration material is minimized. A minimized quantity is a quantity sufficient to surround the sensor component and isolate the sensor component from the ambient environment so that the sensor component temperature matches the material temperature versus the ambient temperature of the oven.

In certain embodiments, the control unit may be arranged to wait until a predetermined number of data points have been recorded before calculating an estimated temperature. This ensures that the temperature is calculated with a desired degree of accuracy. As an example, the control unit may wait until several data points have been recorded after the temperature plateau. In an embodiment, the control unit is also configured to record data about the supplied heating power. The control unit records that the power is being supplied to the heating element. The control unit is further configured to begin calculating an estimated temperature after approximately one to hundreds of transmit cycles to the sensor once the temperature response from the SAW sensor varies no more than approximately 0.5 degrees C. In embodiments, these cycles have a period of approximately one second, meaning that the control unit waits until approximately one to hundreds of data points have been recorded before calculating a temperature. For embodiments, the control unit only calculates the temperature calibration in response to a calibration request. Alternatively, embodiments automatically calibrate the temperature at start-up.

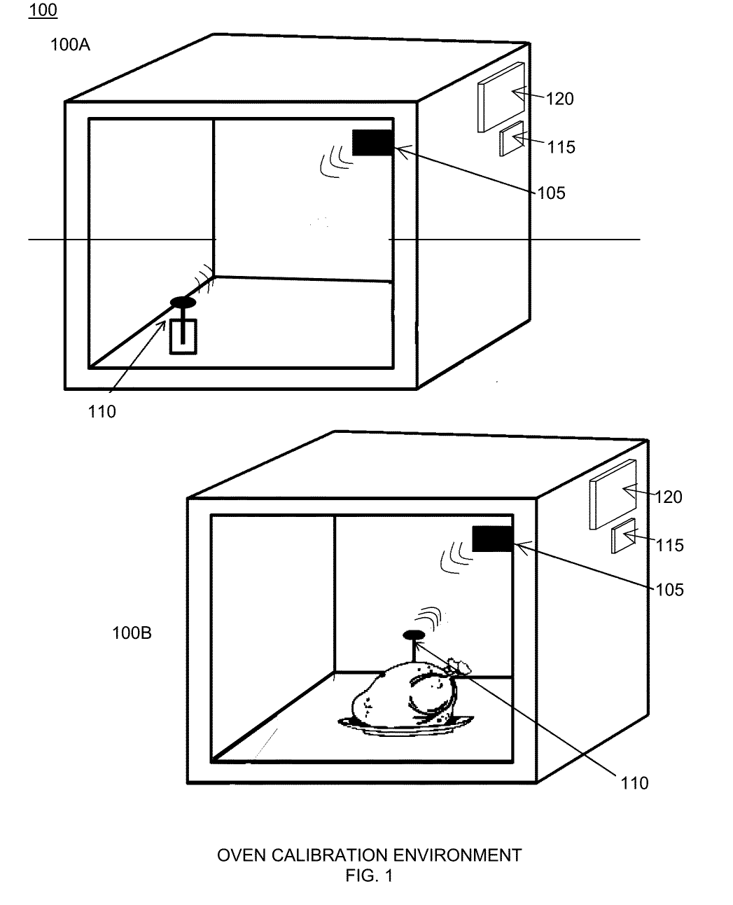

FIG. 1 depicts a simplified oven calibration environment 100. Two steps are shown step one 100A and step two 100B. Step one 100A is the calibration step, and step two 100B is the cooking operation step. In step one 100A, probe transceiver calibration unit 105 transmits signals to food probe 110 for calibration in, as an embodiment example, boiling water. To boil the water, thermostat 115 controls heat source 120. Thermostat 115 turns on heat source 120 until the thermostat reads higher than the change of state (boiling point) of the calibration material (water). Thermostat 115 cycles heat source 120 on and off, above and below the boiling point of the water. The calibration unit performs the calibration process with food probe 110. In step two 100b, food probe 110, after calibration, is inserted in food to be measured. During cooking, heat source 120 is controlled by thermostat 115 with input from probe transceiver calibration unit 105.

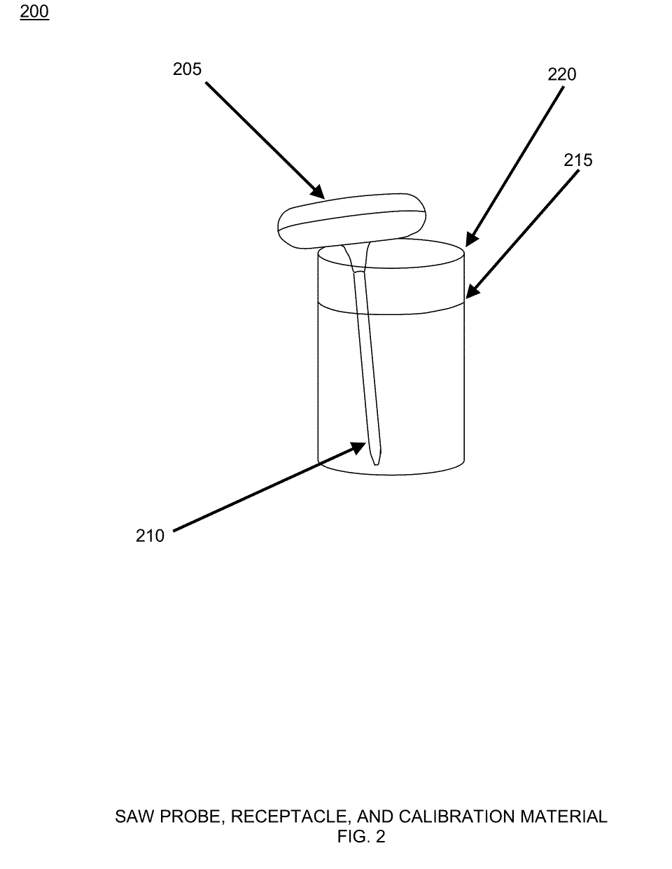

FIG. 2 depicts a SAW probe, receptacle, and calibration material 200. Antenna end of probe 205 is opposite SAW device end of probe 210 for an embodiment. Probe is immersed in calibration material 215 in container 220. As mentioned, for embodiments the quantity of calibration material 215 is minimized.

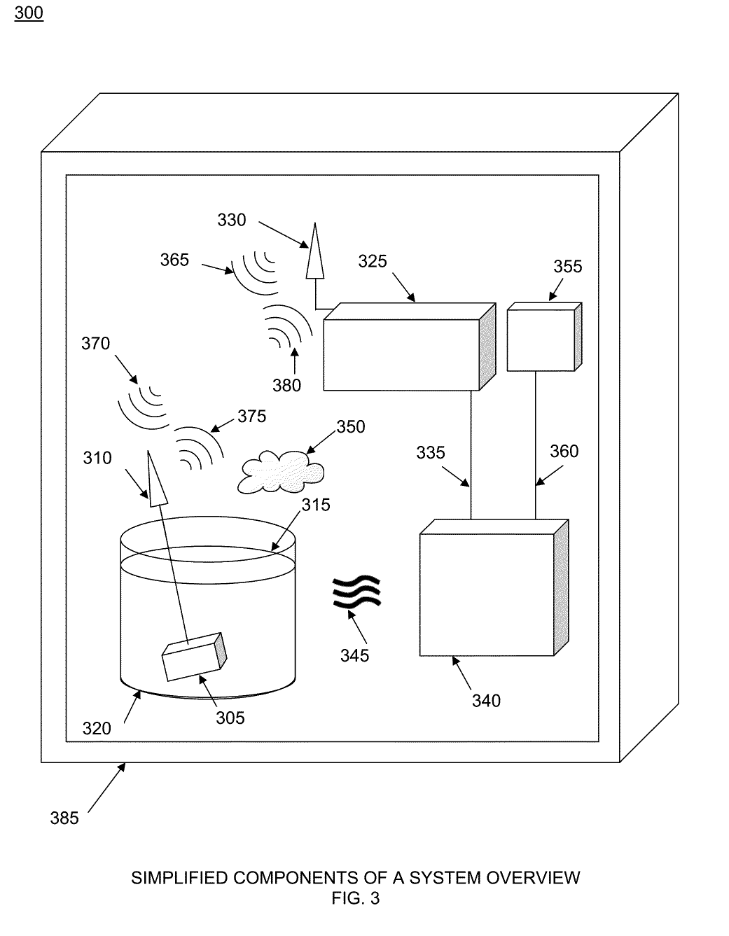

FIG. 3 depicts simplified block diagram components of a system overview 300. SAW sensor 305 electrically connected to probe antenna 310 is in calibration material 315 which is in container 320. Probe transceiver calibration unit 325 is electrically connected to control unit antenna 330. Probe transceiver calibration unit 325 is also connected 335 to heat source 340. Heat source 340 radiates heat 345 to warm calibration material 315 in environment 350. Before calibration, heat source 340 is controlled by thermostat 355 through connection 360. In operation, probe transceiver calibration unit 325 antenna 330 radiates transmit signal 365 to be received 370 at probe sensor antenna 310. After reception, SAW 305 of probe re-radiates received signal 375 which is received 380 at control unit antenna 330. During calibration, thermostat 355 controls heat source 340. Thermostat 355 turns on heat source 340 until the thermostat reads higher than the change of state of calibration material 315. Thermostat 355 cycles heat source 340 on and off, above and below the boiling point of calibration material 315. Probe transceiver calibration unit 325 performs the calibration process with food probe comprising saw sensor 305 and probe antenna 310. Once calibration is complete, control of heat source 340 is transferred from thermostat 355 to probe transceiver calibration unit 325. After calibration, the food probe is inserted in the food to be cooked and, with probe transceiver calibration unit 325, controls heating by heat source 340. For embodiments, system components are enclosed in oven 385. For calibration, probe transceiver calibration unit 325 receives input for calibration material identification including physical properties of the calibration material, and other data about environment 345. This can include altitude and other relevant parameters.

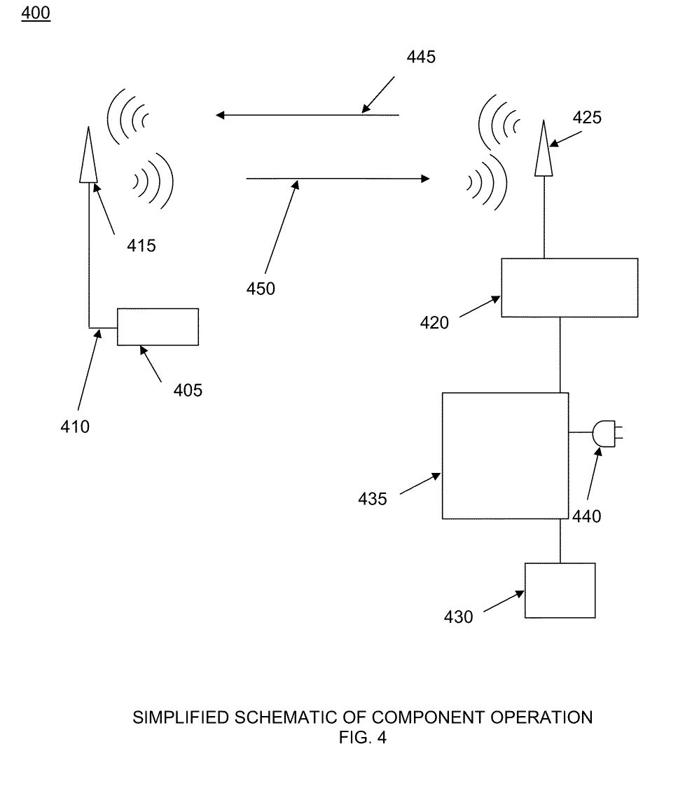

FIG. 4 depicts a schematic of component operation 400. SAW temperature sensor device 405 is electrically connected 410 to sensor antenna 415 for transmit and receive. Probe calibration control unit 420 generates signals to be sent to SAW, and demodulates signal received from SAW sensor through control unit antenna 425. Before and during calibration, thermostat 430 controls operation of heat source 435 receiving external power 440. During calibration, probe calibration control unit 420 generates a signal for the temperature probe SAW sensor 405, and transmits it 445 to be received by probe antenna 415. After reception and acoustic wave interaction, the SAW probe signal is radiated back 445 to be received by control unit antenna 425. Probe calibration control unit 420 then demodulates the signal from the temperature probe SAW sensor to determine the temperature of the SAW device. This bidirectional transmission process is repeated during cooking to determine the temperature of the probe inserted in the food being cooked. After calibration, during cooking, heat source 435 is controlled by thermostat 430 with input from probe calibration control unit 420.

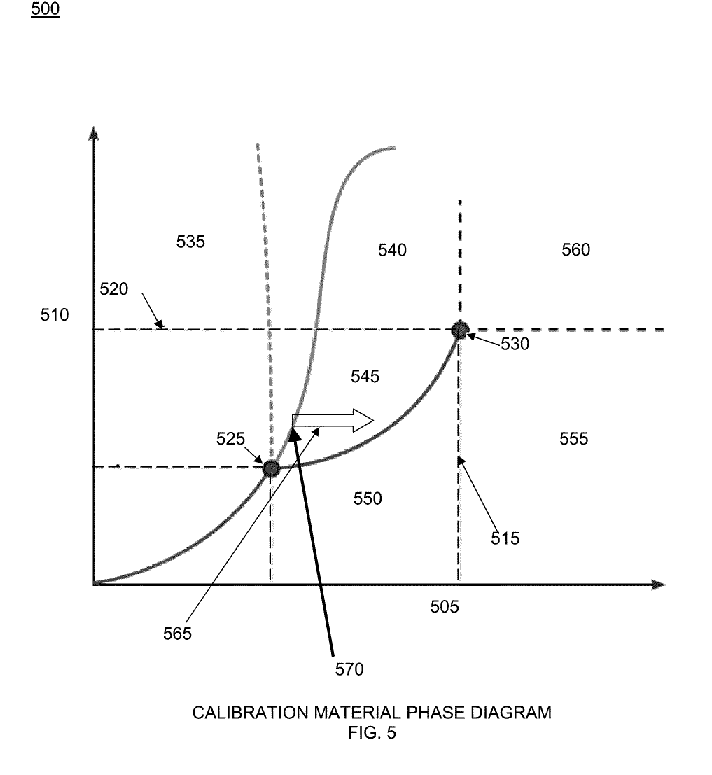

FIG. 5 depicts a calibration material phase diagram 500. It presents a horizontal axis of temperature 505 versus a vertical axis of pressure 510. Two values for temperature and pressure are given, critical temperature T_{cr} 515 and critical pressure P_{cr} 520. Two points are given, triple point 525 and critical point 530. Triple point 525 has a pressure designated Pₜₚ and a temperature designated Tₜₚ. Critical point 530 has values of critical temperature T_{cr} 515 and critical pressure P_{cr} 520. The diagram delineates six phases. These six phases are solid 535, compressible liquid 540, liquid 545, vapor 550, gaseous 555, and supercritical fluid 560. As heat is applied to the calibration material, it passes 565 from liquid phase 545 to vapor phase 550; at boiling temperature point 570 for standard temperature and pressure conditions (STP) this is 100 degrees Celsius for water. A phase transition is the transformation of a thermodynamic system from one phase or state of matter to another. A phase of a thermodynamic system and the states of matter have uniform physical properties. During a phase transition of a given medium, certain properties of the medium change, often discontinuously, as a result of some external condition such as temperature, pressure, and others. For example, a liquid may become gas upon heating to the boiling point, resulting in an abrupt change in volume. The measurement of the external conditions at which the transformation occurs characterizes the phase transition. The enthalpy of vaporization, also known as the heat of vaporization or heat of evaporation, is the energy required to transform a given quantity of a substance from a liquid into a gas at a given pressure (typically atmospheric pressure). It is commonly measured at the normal boiling point of a substance. The heat of vaporization is temperature-dependent, though a constant heat of vaporization can be assumed for small temperature ranges and for Tr<<1.0. The heat of vaporization diminishes with increasing temperature and it vanishes completely at the critical temperature (Tr=1) because above the critical temperature the liquid and vapor phases no longer co-exist. Molecules in liquid water are held together by relatively strong hydrogen bonds, water's enthalpy of vaporization, 40.65 kJ/mol, is more than five times the energy required to heat the same quantity of water from 0° C. to 100° C. (cp=75.3 J K-1 mol-1). Therefore, given a fixed heat input, there will be up to five times the amount of time to boil away a volume of water than to raise its temperature from 0 TO 100° C. This provides sufficient time during the temperature plateau to complete calibration readings by a SAW sensor.

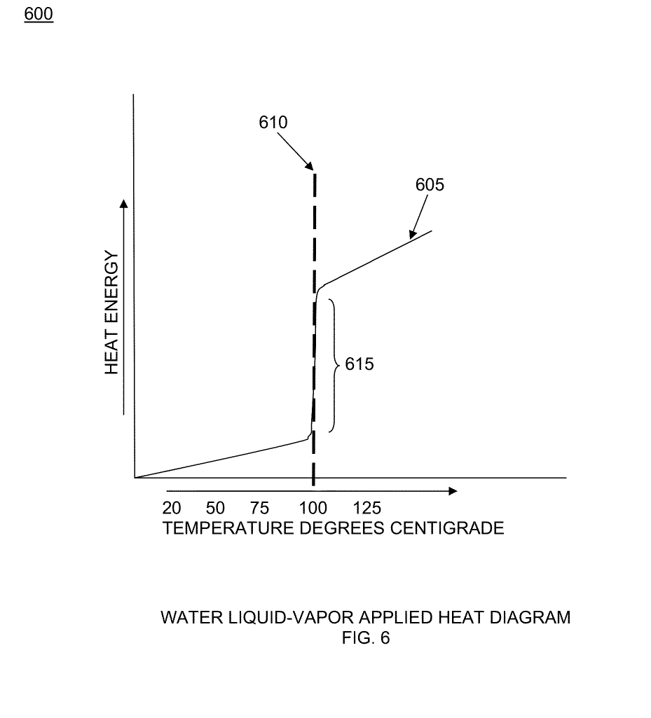

FIG. 6 depicts a water liquid-vapor applied heat diagram 600. It depicts temperature 605 of calibration material including boiling point temperature 610 at 100 degrees Centigrade. Pressure is assumed fixed, at atmospheric pressure of about 14.696 psi or 101.325 kPa at sea level. For approximately every 500 feet of altitude, water's boiling point is lowered 1° F. Change of state is shown 615 where increasing heat energy transitions water from liquid to vapor phase without a change in temperature. The boiling point is the temperature at which the vapor pressure is equal to the atmospheric pressure around the water. This effect is employed to calibrate the SAW temperature sensor probe.

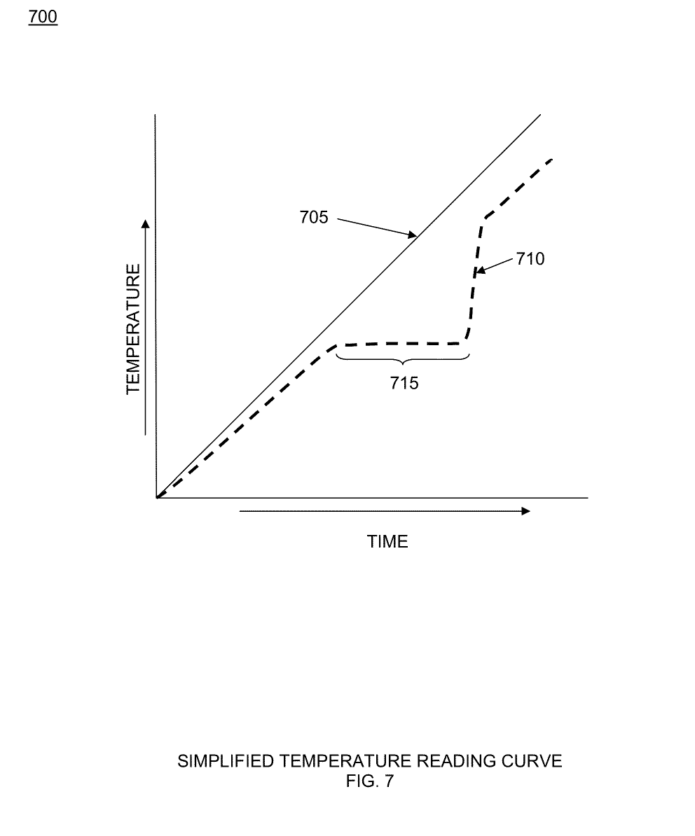

FIG. 7 depicts a simplified temperature reading curve 700. This graph of temperature versus time depicts the effect used for calibration. With a constant heat application, the ambient temperature of the air linearly increases 705. In contrast, the calibration material temperature curve exhibits nonlinearity at change-of-state 710. At the boiling point/change-of-state of the calibration material, the temperature plateaus 715.

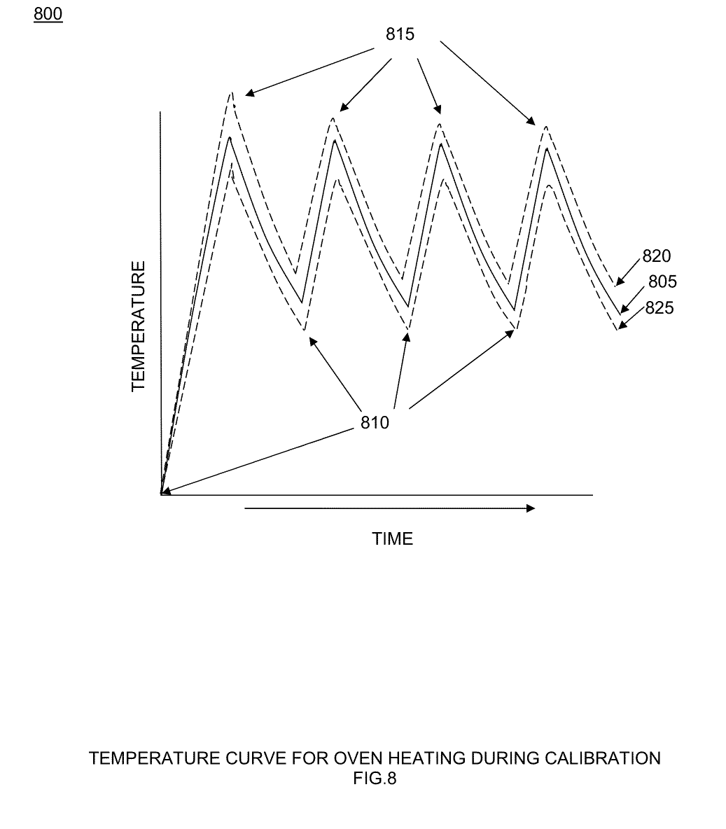

FIG. 8 depicts a temperature curve 800 for oven heating during calibration. This graph of temperature versus time depicts the actual variation of oven environment temperature as controlled by the thermostat. Solid line 805 illustrates the saw tooth temperature profile as the heating element is turned on, points 810 and off, points 815 in an attempt to maintain a stable temperature. In addition, errors exist in the temperature shown by over-temperature dashed line 820 and under-temperature dashed line 825. In some cases, thermostat inaccuracies can be from +/−5 to 15 degrees Celsius. In contrast, SAW temperature sensors have fast time constants, high accuracy, high precision, high linearity, and little drift over time. Use of the calibrated food probe to measure actual food temperature to determine when the food is cooked to a certain point provides reliable cooking results in spite of actual oven temperature swings.

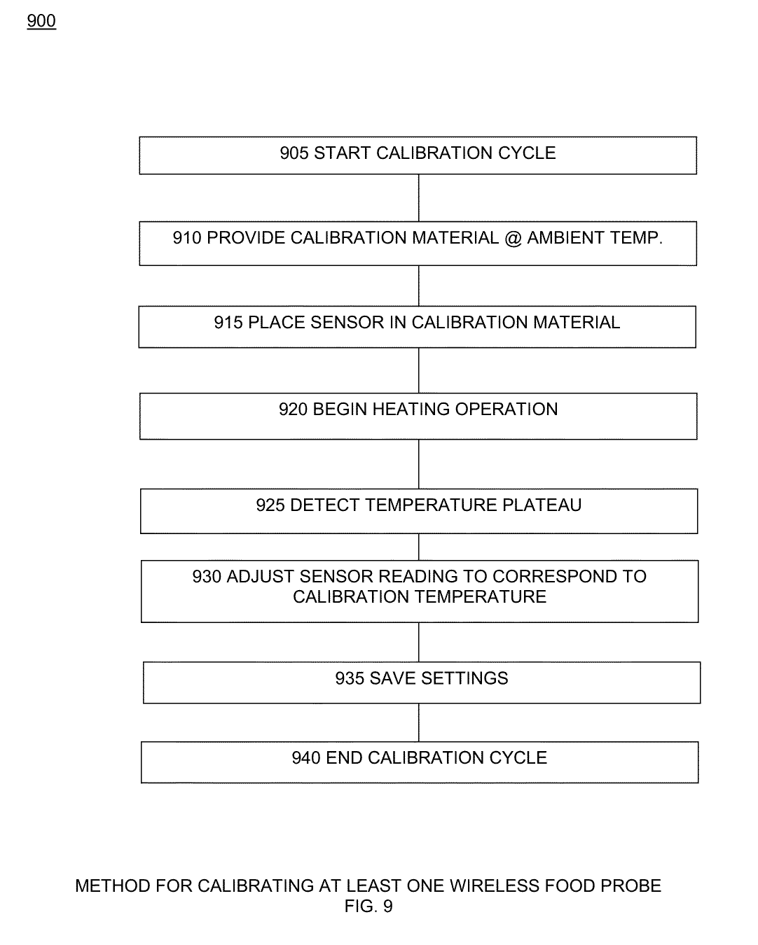

FIG. 9 is a system flow chart of an overview of a method 900 for calibrating at least one wireless food probe. Steps comprise starting calibration cycle 905; providing calibration material (at ambient temperature) 910; placing at least one sensor in calibration material 915; beginning heating operation 920; detecting temperature plateau of calibration material 925; adjusting the sensor reading to correspond to calibration temperature 930; saving settings 935; and ending calibration cycle 940.

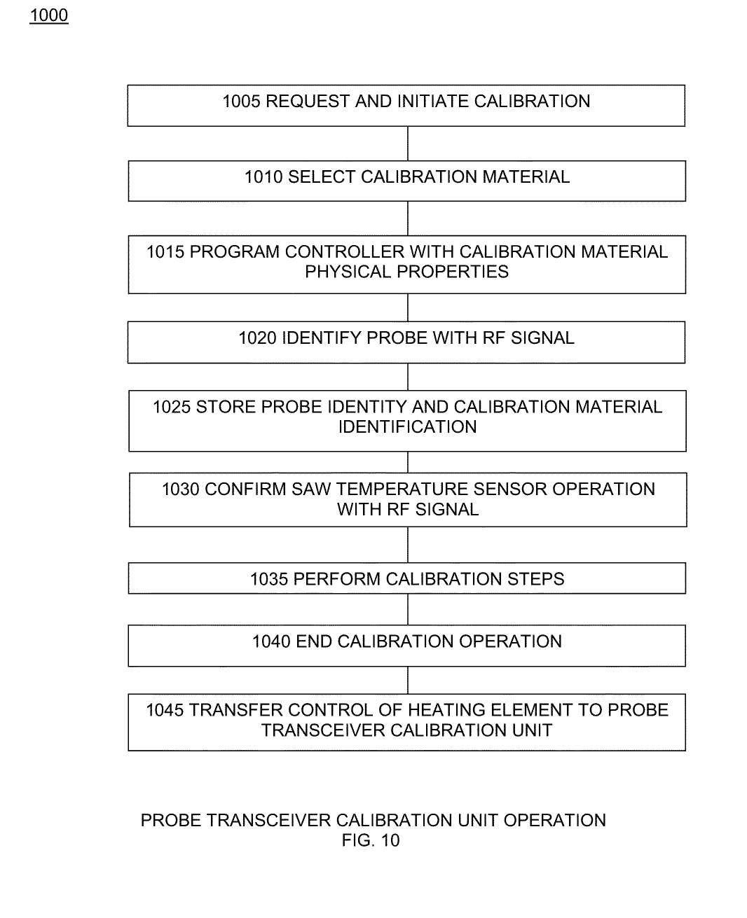

FIG. 10 is a flow chart of a method 1000 for probe transceiver calibration unit operation for calibrating at least one wireless food probe. Steps comprise requesting and initiating calibration 1005; selecting calibration material 1010; programming a controller with calibration material physical properties values including change-of-state temperature 1015; identifying probe with RF signal 1020; storing probe identity and calibration material identification 1025; confirming SAW temperature sensor operation with RF signal 1030; performing calibration steps 1035; ending calibration operation 1040, transferring control of heating element to probe transceiver calibration unit 1045.

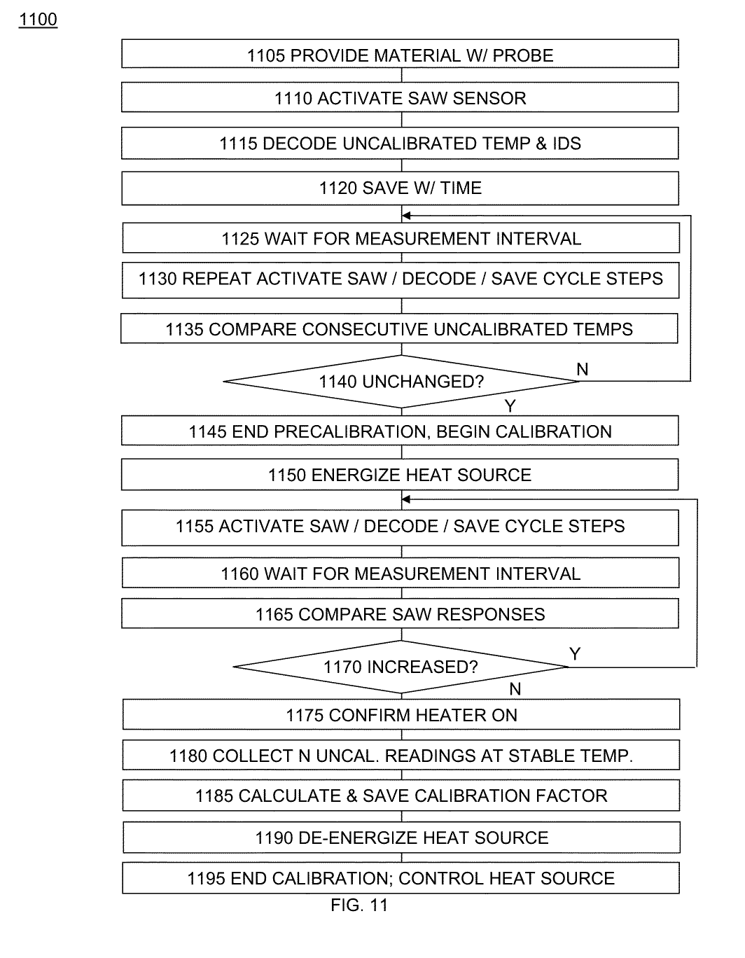

FIG. 11 is a flow chart of details of a method 1100 for calibrating at least one wireless food probe. Steps comprise initiating calibration steps by providing a calibration material with the wireless food probe immersed in it 1105; in a ‘pre-calibration’ sequence activating SAW temperature sensor with RF signal 1110; decoding uncalibrated temperature and probe ID from the SAW response signal 1115; saving the uncalibrated temperature associated with the probe and calibration material identifications and time 1120; waiting for measurement interval 1125; repeating activating decoding and saving cycle 1130; comparing consecutive uncalibrated temperatures from SAW 1135; checking to determine if temperature is unchanged, stable at ambient temperature 1140; if not unchanged—N, go to wait for measurement interval 1125, if unchanged—Y, go to temperature stable (at ambient temperature—end of pre-calibration sequence), ready to begin calibration 1145; next, begin energizing heat source controlled by a thermostat set to at least the change-of-state temperature of the calibration material 1150; perform activate (SAW sensor)/decode (SAW sensor response)/save (SAW response, probe and calibration material identifications, and time) cycle 1155; waiting for measurement interval 1160; comparing consecutive uncalibrated temperature sensor responses from SAW 1165; checking to determine if temperature reading has increased 1170; if temperature has increased—Y, go to activate/decode/save cycle 1155, if temperature has not increased—N confirm that the heater is on 1175 if not on, go to 1150 to energize the heat source; collecting quantity “n” uncalibrated temperature reading repetitions at the stable temperature if heater is confirmed on 1180; calculating and saving the calibration factor for the SAW probe and material by the respective identifications 1185; de-energizing the heat source 1190; ending calibration steps and controlling heat source by thermostat with input from probe calibration control unit 1195.

The foregoing description of the embodiments of the invention has been presented for the purposes of illustration and description. Each and every page of this submission, and all contents thereon, however characterized, identified, or numbered, is considered a substantive part of this application for all purposes, irrespective of form or placement within the application. This specification is not intended to be exhaustive or to limit the invention to the precise form disclosed. Many modifications and variations are possible in light of this disclosure. The embodiments may be modified, and all such variations are considered within the scope and spirit of the application. The components of the system may be integrated or separated. Moreover, the operations of the system may be performed by more, fewer, or other components. The methods may include more, fewer, or other steps. Additionally, steps may be performed in any suitable order. Many modifications and variations are possible in light of this disclosure.

What is claimed is:

1. An apparatus for calibrated control of a cooking oven comprising:
an oven heat source (120);
a thermostat (115) providing temperature control signals to said heat source (120);
a wireless temperature probe (110), said probe comprising a sensor body, at least one surface acoustic wave (SAW) temperature sensor (305), and at least one sensor antenna (310);
a separate probe transceiver calibration unit (105, 325) receiving temperature information from said temperature sensor of said probe, said probe transceiver calibration unit comprising an antenna (330) electrically connected to said probe transceiver calibration unit (105, 325);
a calibration material (315) in a calibration material container (320);
said probe transceiver calibration unit (105, 325) receiving thermal properties of said calibration material and configured to calculate a calibration factor to apply to a decoded uncalibrated temperature reading from said probe, producing a calibrated temperature from said probe;
whereby said oven thermostat (115) receives calibrated temperature reading control input from said probe transceiver calibration unit (105, 325).

2. The apparatus of claim 1 comprising a pre-calibration sequence (1110-1140).

3. The apparatus of claim 1 wherein said probe is calibrated without a reference temperature sensor.

4. The apparatus of claim 1 wherein calibration is accomplished at a single temperature point (570, 615, 715), and calibration calculations are performed in said probe calibration unit (105, 325).

5. The apparatus of claim 1 wherein said probe (110) comprises a response time of at least about one second, an accuracy of about 0.5 degrees C., a precision of about at least 0.5 degrees C., a linearity of about 1% over a temperature range of about 0 to about 250 degrees C., and a drift of less than about 0.1 degree C. per year.

6. The apparatus of claim 1 wherein quantity of said calibration material is minimized.

7. The apparatus of claim 1 comprising ending a pre-calibration sequence when SAW sensor measured temperature varies by no more than approximately 0.5 degrees Celsius.

8. A method for calibrating a culinary probe comprising the steps of:
providing a calibration material (910);
placing one sensor in said calibration material in an oven (915);
beginning a heating operation by controlling a heat source by a thermostat (920);
detecting a temperature plateau of said calibration material in a probe calibration unit (925);
adjusting a reading of said sensor to correspond to a calibration temperature (930);
saving settings (935); and
controlling said heat source by said thermostat receiving calibrated temperature control input from said probe calibration unit (1195).

9. The method of claim 8 comprising:
receiving information about heating power, thermal properties of said calibration material; probe unique identifier; and calibration material unique identifier at said probe calibration unit (1015), and recording, at said probe calibration unit, a time at which a temperature of said calibration material does not increase (1185).

10. The method of claim 8 comprising:
storing, in said probe calibration unit, said information about a correlation between said time at which the calibration material temperature does not increase and thermal properties of said calibration material; and
said probe unique identifier (1185).

11. The method of claim 8 comprising:
calculating, in said probe calibration unit, a calibration factor to apply to said decoded uncalibrated temperature reading from said probe, producing a calibrated temperature from said probe (1185).

12. The method of claim 8 comprising a pre-calibration sequence comprising:
activating a SAW temperature sensor with an RF signal (1110);
decoding uncalibrated temperature and probe ID from a SAW response signal (1115);
saving said uncalibrated temperature associated with said probe and calibration material identifications and time (1120);
waiting for a measurement interval (1125);
repeating activating decoding and saving cycle (1130);
comparing consecutive uncalibrated temperatures from said SAW (1135);
checking to determine if temperature is unchanged, stable at ambient temperature (1140);
if not unchanged, wait for said measurement interval, if unchanged, temperature is stable at ambient temperature, ending said pre-calibration sequence.

13. The method of claim 8 comprising:
collecting approximately 300 data points for calibration calculation, and collecting data from said probe at about one second intervals.

14. The method of claim 8 comprising:
immersing said probe in water calibration material, and removing said calibration material from said oven after completion of calibration and cooking initiation.

15. A system for calibrating a culinary probe comprising:
activating a SAW temperature sensor with an RF signal (1110);
decoding uncalibrated temperature signal and probe ID from a SAW response signal (1115);
saving said uncalibrated temperature associated with said probe and calibration material identifications and time (1120);
waiting for a measurement interval (1125);
repeating said activating, decoding, and saving cycle steps (1130);
comparing consecutive uncalibrated temperatures from said SAW sensor (1135);
checking to determine if temperature is unchanged, stable at ambient temperature (1140);
beginning energizing a heat source controlled by a thermostat (1150);
performing a sequence comprising activating said SAW sensor, decoding a SAW sensor response, saving said SAW response, probe and calibration material identifications, and time (1155);
waiting for said measurement interval (1160);
comparing consecutive uncalibrated temperature sensor responses from said SAW sensor (1165);
checking to determine if temperature reading has increased (1170);
if temperature has increased, repeating said activating, decoding, saving cycle steps (1155);
if temperature has not increased, confirming that said heat source is on (1175);
collecting a predetermined quantity of uncalibrated temperature reading repetitions at a stable temperature (1180);
calculating and saving a calibration factor for said SAW probe and said material by said respective identifications (1185);
de-energizing said heat source (1190);
ending calibration steps; and
controlling said heat source by said thermostat receiving calibrated temperature control input from a probe transceiver calibration unit (1195).

16. The system of claim 15, comprising collecting a predetermined quantity of uncalibrated temperature reading repetitions at said stable temperature only if said heat source is confirmed to be on (1180).

17. The system of claim 15, comprising setting a setpoint temperature of said thermostat to at least a change-of-state temperature of said calibration material (1015).

18. The system of claim 15, comprising energizing said heat source (1150) if said heat source is determined to not be on at said step of confirming that said heat source is on (1175).

19. The system of claim 15, wherein power supplied to said heat source during heating is varied proportionate to a thermal inertia of said calibration material, whereby a given time for calibration is maintained.

20. The system of claim 15, comprising:
requesting calibration to initiate said calibration at said probe transceiver calibration unit (1005);
selecting said calibration material (1010);
programming a controller in said probe transceiver calibration unit with calibration material physical properties values including change-of-state temperature (1015);
identifying said probe from said probe ID from said RF signal (1020);
confirming SAW temperature sensor operation with RF signal (1030);
transferring control of said heat source to said probe transceiver calibration unit (1045) from said thermostat.
